(19) United States
(12) Patent Application Publication
(10) Pub. No.: US 2013/0320720 A1
(43) Pub. Date: Dec. 5, 2013

(54) DISPOSABLE PROTECTIVE SEATING COVER FOR PROMOTION AND ADVERTISING

(71) Applicant: Mary D. Steinmetz, Minneapolis, MN (US)

(72) Inventor: Mary D. Steinmetz, Minneapolis, MN (US)

(21) Appl. No.: 13/899,367

(22) Filed: May 21, 2013

Related U.S. Application Data
(60) Provisional application No. 61/650,001, filed on May 22, 2012.

(51) Int. Cl. A47C 7/62; G09F 23/00

(52) U.S. Cl. CPC A47C 7/62; G09F 23/00
USPC 297/219.1

(57) ABSTRACT

A form-fitting protective seating cover which protects seating features, such as headrests, backs and chair surfaces, which includes surfaces for the display of promotions and advertising content, in which the seating cover is structurally designed for numerous types of row-based seating arrangements to take advantage of these unique properties. The seating cover is further constructed to be protective, disposable, and even biodegradable, and customizable for the desired seat dimensions, lighting needs and color themes, all within a cost-effective context.

### CLAIM OF PRIORITY

This application claims priority to U.S. Provisional Patent Application Ser. No. 61/650,001 filed May 22, 2012 entitled “Disposable Protective Seating Cover for Promotion and Advertising”, and is herein incorporated by reference in its entirety.

### FIELD AND BACKGROUND OF THE INVENTION

The invention is directed generally to a protective seating cover.

A wide variety of protective seat, chair and headrest coverings are known in the art. Additionally, there are numerous examples of coverings that are useful in conveying protective properties such as disposable hygiene products. In addition, many of these protective coverings are made to be disposable, which reduces the need for extensive cleaning, which is expensive. Many are however, unsightly or not form fitting enough to be utilized properly. Still others are only usable in situations where there are special fasteners or receivers available.

There are many examples of disposable seat and headrest covers known in the art, many of which are directed to protective or hygienic uses or purposes. By way of example, U.S. Pat. No. 6,655,734 (2003) describes a line of hygiene products, specifically disposable sanitary seat covers for children for shopping carts, high chairs and the like.

Earlier examples include U.S. Pat. No. 4,206,945 (1978) which describes a removable and disposable back and head cloth with an adhesive strip for adhering the cloth to the seat. U.S. Pat. No. 3,804,458 (1973) describes a yarn sewed to the cover to use to attach the cover to the attaching means (Velcro) connected to the back of the seat. U.S. Pat. No. 3,654,059 (1969) describes disposable covers of non-woven fabric for beds, chairs and other articles of furniture. See also U.S. Pat. No. 3,691,005, U.S. Pat. No. 3,635,523, and U.S. Pat. No. 3,063,749 for further examples of previous efforts in the field.

Several other improvements have been made over the years as it relates to adhesive and engagement devices, as well as for the nature of the fabrics. Patent App. No. U.S. 2008/0191529 describes an elasticized disposable seat cover that slips over the entire seat. Patent App. No. U.S. 2007/0257533 improved features for securing and attaching a cover to a headrest cover including the use of elastic elements and/or drawstring cords.

Various industries have attempted to address hygienic and functional uses of seating, chair and headrest covers. Many of these surfaces, whether seating in movie theatres, mass transportation, or other public seats, are occupied by many people and present a legitimate source for contamination, as many people come in contact with such surfaces. In addition, the frequency and effectiveness of the cleaning of such seats is often inconsistent and unregulated. Often, the expense of ensuring the safety of seat occupants has caused many industries to ignore or downplay the need for effective hygienic solutions. Further, mechanisms for addressing these unprotected surfaces are often too expensive and cumbersome, with no additional benefit which would attract industry acceptance.

In order to address additional functionality seat coverings have seen some improvement in the art. See U.S. Pat. App. No. 2007/0210629 which describes a fitted sheet for a plane or train seat having a cotton hood section to attach to the top, a main body section, an attachment means and a carrying bag.

Other improvements have utilized these media for additional features. U.S. Pat. App. No. 2006/0033366 describes a seat headrest cover display device having a removable device for placing advertising materials in. U.S. Pat. App. No. 2006/0155600 describes generally utilizing advertising on existing products. U.S. Pat. App. No. 2005/0102179 again, describes adding promotional information to existing products, such as retail shopping bags.

The lack of industry acceptance in protective seating covers has been well-established, yet there remains a significant need in ensuring sanitary conditions with public seating. Addressing the opportunity for promotional and advertising information has been considered, but the additional efforts to increase the viability of protective covers to address these opportunities requires substantial structural features, retrofitting and cost, and these attempts have actually worked against the disposable and sanitary features that are desired with protective covers. Further, the burden on industries to ensure replacement of such covers is not offset by any currently available feature in using such seating covers.

In order to overcome these shortcomings, die invention provides for a protective seating cover constructed of a disposable, protective fabric, which is designed in a manner which attaches appropriately and does not interfere with the use of the seating, and which further provides the additional benefit of providing an advertising or promotional medium.

### SUMMARY OF THE INVENTION

It is therefore an advantage of the invention to solve one or more of the aforesaid limitations via appropriate design and fit features coupled with appropriate fabric and additional useful features. More particularly, the invention is designed to provide a protective seating cover which includes promotions and advertising, in which the invention is structurally designed for numerous types of row-based seating arrangements to take advantage of these unique properties.

In accordance with various aspects, the present disclosure is directed to a protective seating cover which comprises a fabric with an outer and an inner surface, in which each surface is configured for protection and graphic representations on each surface. The size of the seating cover is customizable and tailored for the particular seating dimensions and formed to fit without excess billowing or folding required.

An exemplary aspect of the invention is that the protective seating cover provides for the use of the fabric of the cover for promotion or advertising and may include printed advertisements on both the inner and the outer layer for reversible, or multiple use, as well as for either side of the seat or ideally, in darkened locations, such as cinema theatres or performance venues, the reversible feature ensures the application of the protective seating cover is correct regardless of which side is used or which inner or outer layer.

There are other advantages to this approach as well. For example, according to some aspects, additional colors and sizes may be appropriate for the nature of the use, such as black for cinema theatre seats, or cut in a manner which covers all or a part of the seat, such as the headrest only, or the entire headrest, back, and chair portions. This may allow for additional features to be provided, such support and shaping features of the invention.

Further, the invention is designed with fabric that is disposable. In some aspects, the protective fabric is fabricated to be biodegradable. In some aspects, the protective fabric has antimicrobial or biocidal properties incorporated into the fabric. The fabric may further perform be a wicking fabric or mesh. In some aspects, the fabric may contribute to absorbance of moisture, such as perspiration absorption or moisture absorption fabrics and may be made from form-fitting fabrics, such as LYCRA® or other synthetic fabrics. In other aspects, the outer layer is made from natural fibers such as cotton, wool, or silk. In even other aspects, the fabric may be knitted, woven, or nonwoven.

The invention further provides for secure attachment by having the bottom of the protective seating cover comprise an elastic opening, which tightens the cover once placed over the desired seat. Additional tightening features known in the art may also be incorporated. The invention may alternatively have no tightening features incorporated into the lower opening.

In some aspects, the fabric may have various colors based upon the desire, location, or lighting of the venue. In some aspects various thread colors may be used to distinguish or high-light or accent desired logos graphics.

Another aspect of the invention is the incorporation of desired fragrances into the protective seating cover, which may be utilized using perfumed fabrics, wherein scents are woven or otherwise incorporated into the protective seat cover, for desired scents or signature scents for product reference.

Another aspect of the invention is that the protective seating cover, once ordered by the user, is packaged in a dispenser which can be utilized for rapid application to the facility's seating arrangements.

The invention further provides for secure attachment to seating by using fabric that is electrostatic or microfiber, in which the fabric is treated to be negatively charged. The electrostatic fiber may further be utilized for externally attaching advertising or promotional materials to the exterior surfaces of the protective seating cover.

The invention thus addresses the shortcomings of the previous attempts to address the viability and feasibility of protective seat covers by utilizing embodiments which comprise the following: fabricating the covers with disposable, biodegradable, protective fabric; making the covers customized to the desired seats and easy to use—whether with installation or removal; customizing the covers to the desired use; providing advertising and promotional space that provide advertisers with an innovative, affordable and non-traditional advertising opportunity which in turn offsets the cost burden to seating venues and potentially a new revenue source; placing such advertising and promotional features on the front and back of the cover, as well as the inside or outside of the fabric surface to ensure ease of installation; and, providing the protective seat covers in dispenser-like packaging for ease of removal during installation. The inventions is thus ideal for movie theaters, performance art venues, school auditoriums, trains, airplanes, buses, cars, and other rowed seating arrangements.

### BRIEF DESCRIPTION OF DRAWINGS

FIG. 1 is a frontal perspective view of the protective seat cover.

FIGS. 2A and 2B are views of an example embodiment of the invention in a commercial setting, such as a theater.

### DETAILED DESCRIPTION OF THE INVENTION

While the making and using of various embodiments of the invention are discussed in detail below, it should be appreciated that the invention provides many applicable inventive concepts that can be embodied in a wide variety of specific contexts. The specific embodiments discussed herein are merely illustrative of specific ways to make and use the invention and do not delimit the scope of the invention.

It is contemplated that any embodiment discussed in this specification can be implemented with respect to alternative arrangement of the invention, and vice versa.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications, patents, and patent applications are herein incorporated by reference to the same extent as if each individual publication or patent application was specifically and individually indicated to be incorporated by reference.

To facilitate the understanding of this invention, a number of terms are defined below. Terms defined herein have meanings as commonly understood by a person of ordinary skill in the areas relevant to the invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof as used herein refers to all permutations and combinations of the listed items preceding the term. For example, “A, B, C, or combinations thereof is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

In the description which follows like parts may be marked throughout the specification and drawings with the same reference numerals, respectively. The drawing figures are not necessarily to scale and certain features may be shown exaggerated in scale or in somewhat generalized or schematic form in the interest of clarity and conciseness.

Synthetics or synthetic fabrics refer principally to polyester and polyester blends. Some synthetic fabric blends use high percentages of nylon (as a means of increasing abrasion resistance), or they add small amounts of spandex or elastin (to enhance stretch). Polyester, though, is a dominant synthetic fiber. Rayon, or viscose, is also preferred.

Collectively, fabrics include synthetic fabrics, wools, silks, cottons, wicking fibers, quick-drying fabrics, and perspiration absorptive materials, as well as yarns such as hydrophilic nylon, cotton, rayon and blends of hydrophilic nylon and conventional nylon. However, other synthetic or hydrophobic fabrics or yarns may be substituted as desired. Polypropylene fibers or specially treated nylon fibers may be substituted for the polyester fibers for attaining a similar comfort and protective effect.

Form-fitting means to an article of manufacture or fabric one that tightly follows the contours of the portion of the item being covered.

Nonwoven shall mean interlaid fibers without weaved or knitted features. Needle punched fabrics are exemplary of nonwoven fabrics.

Reversible shall mean to an article of the invention to be finished so that either side may be used. Further, reversibility shall include forward and backward uses, and vice versa.

Antimicrobial refers principally to the ability of a substance or material to kill or inhibit the growth of microorganisms, such as bacteria, fungi, protozoans, or viruses.

Elastic refers an elastomer, or polymer with viscoelasticity that is capable of reversible extension ranging from 5-700%, and is capable of exerting tension consistently upon extension from an unstressed position.

Advertising or advertising content refers to any representation on the surface of fabric which contains a form of communication used to encourage or persuade a viewer or reader to continue or to take new action. Typically, the desired result is to drive consumer behavior with respect to a commercial offering. Advertising content is usually paid for by sponsors that are desirous of generating increased consumption of their goods or services.

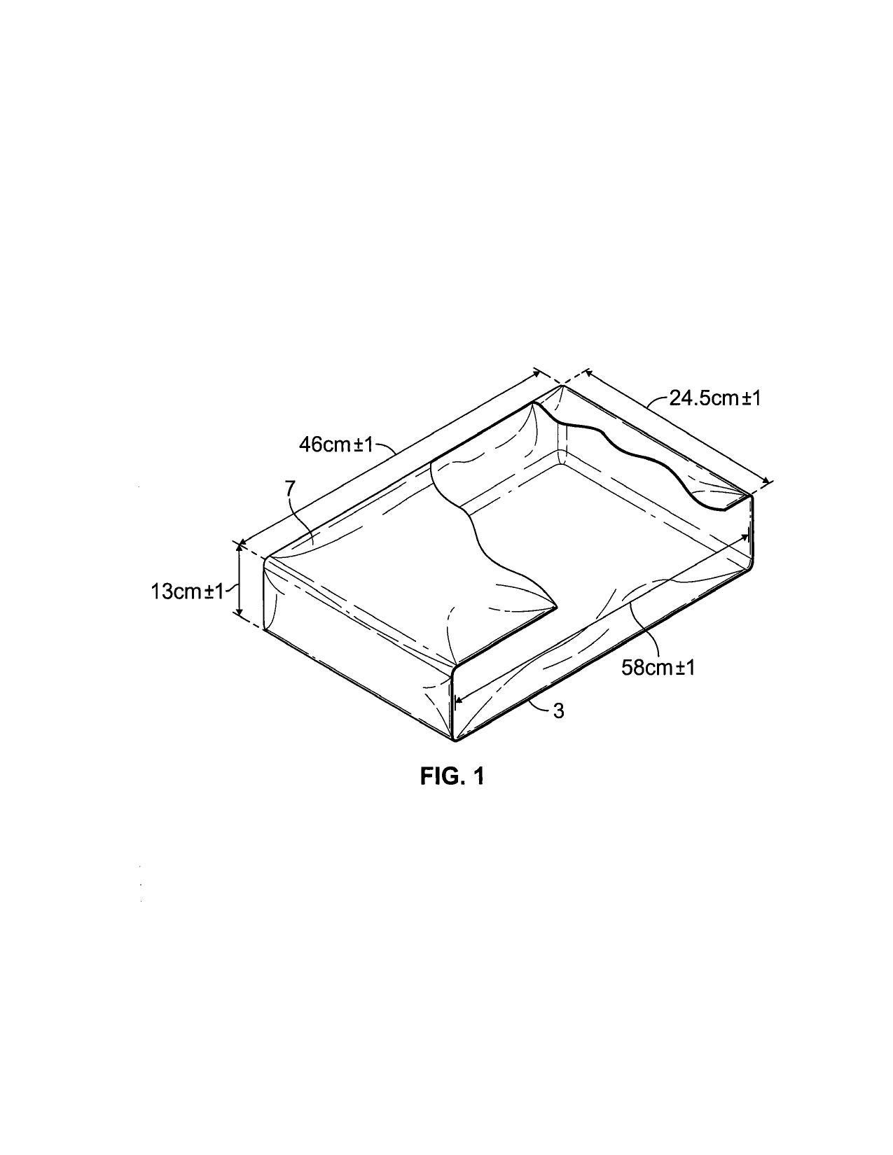

Front and rear corresponds to the seat itself, rather than to suggest any position the cover assumes when it is positioned over the seating configurations. As such, the rear view of FIG. 1 of the invention refers to the rear of the seating configuration in order to further provide explanation of a preferred embodiment of the invention as shown.

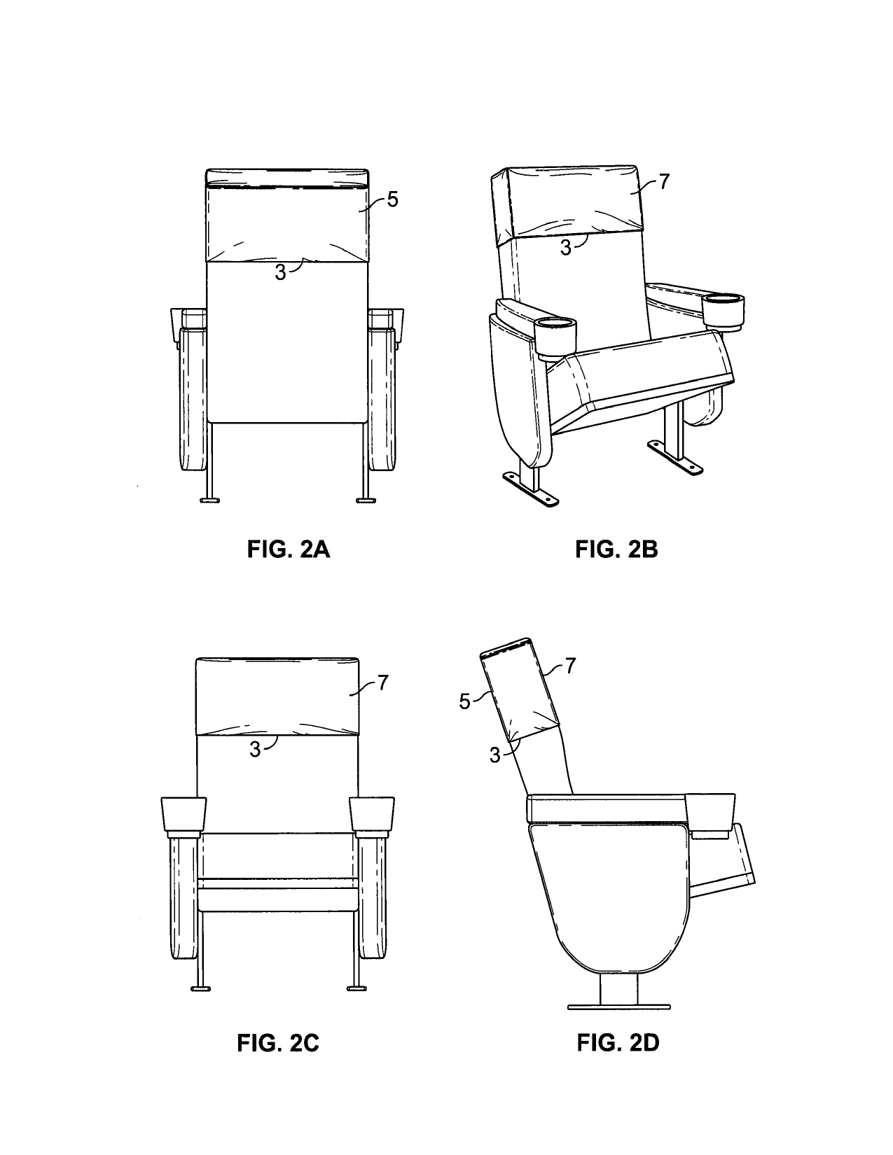

Reference is now made to FIGS. 1 and 2A-2B of the drawings for a detailed description of the preferred embodiments. Turning to the invention described in FIG. 1 of the drawings which discloses the invention as it is designed for a seat back, the rear portion is comprised of a fabric cut in a manner to extend across a desired seating configuration. The rear and the frontal portions of the fabric are then attached to end fabric portions on the right and left sides. The versatility of the invention provides for stitching or fastening of the fabric frontal and side portions independently or for utilizing a bilateral configuration wherein the frontal portion and the rear portion fold to meet, thus having no separate side fabric portions. Depending on the desired seating configuration, variations of the stitching or attachment patterns will become apparent to those skilled in the art to which the invention pertains.

The rear portion of the invention is typically reciprocal to the frontal portion, and the properties of both fabrics are mirrored, with each having reversible features to allow for reversible use and for incorporation of the various features disclosed herein. Alternatively the front and rear portions have separate and distinct features, where a user of the seat would interface with the protective seat cover may have various incorporated features such as the antimicrobial, anti-moisture, or other protective features.

The lower portion 3 then comprises an elastic component made by LYCRA®, rubber, elastic polymers, or other elastic substances. The elastic elements may be attached to the cover by woven, sewn, punched, stapled, or other adhesive or fastening means. Alternatively, the lower portion has other tightening features which are known to those skilled in the art to which the invention pertains. The invention may further be utilized with no elastic or other tightening features in instances where there are adequate tightness ensured from the fit of the protective seat cover or for when electrostatic features are utilized.

In a preferred embodiment, the entire cover is constructed of a nonwoven fabric. In another embodiment the cover is constructed of a rayon/viscose fabric. Preferably the cover is constructed of a nonwoven rayon and polyester blended fabric, more preferably a 70% rayon/viscose and 30% polyester blend. The fabric may further be multi-layer composite fabric having an inner layer which provides moisture management and an outer layer which is both protective and supportive. Each layer is suitably attached to the other by standard sewing techniques or by nonwoven or needle punching techniques.

### Example 1

The present example embodies the general nature of FIG. 1, which forms an integral part of this specification. A protective seat cover forms for a desired seating back for use in a cinema theatre setting. The fabric is made of a disposable nonwoven material with approximately 70% rayon/viscose 30% polyester blend. The rear portion, shown with the advertising feature on FIG. 1 is approximately 22.8 inches (58 cm) wide and 9.6 inches (24.5 cm) in height. The opposing portion, the portion to which the user of the seat faces, is 15 cut into a more narrow width, 18.1 inches (46 cm) to account for the tapering in the seat from the rear to the front, mostly due to the shape of the cushion feature of the seat. The sides of the protective seat cover are configured for a depth of 5.1 inches (13 cm).

The fabric is colored black in order to correspond to the traditionally dim lighting in order to provide a significant contrast to the desired advertising content to be provided—in this example—SEATCAPS™—Clean Advertising. The desired advertising information in represented on both the inner and outer layers of both the front and rear portions to provide for reversible capabilities.

### Example 2

FIGS. 2A and 2B are views of an example embodiment of the invention in a commercial setting, such as a theater. In related embodiments, the invention is usable in sports stadium seating, sports or fan bus seating, party bus seating and as coverings for regular chairs.

All of the features and embodiments disclosed and claimed herein can be made and executed without undue experimentation in light of the present disclosure. While the features and embodiments of this invention have been described in terms of preferred embodiments, it will be apparent to those of skill in the art that variations may be applied to the embodiments of the invention described herein without departing from the concept, spirit and scope of the invention. All such similar substitutes and modifications apparent to those skilled in the art are deemed to be within the spirit, scope and concept of the invention as defined by the appended claims.

What is claimed is:

1. A cover for securing to a seat for providing a protective seating cover comprising:
a fabric having an inner layer and an outer layer;
wherein the fabric comprises one or more surfaces for presenting graphical or written advertising content.

2. The seating cover of claim 1, wherein the lower portion of the seating cover comprises an elastic member for form fitting the cover to the seat.

3. The seating cover of claim 1, wherein the seating cover is made of a nonwoven fabric.

4. The seating cover of claim 1, wherein the seating cover is made of a rayon/viscose and polyester blend.

5. The seating cover of claim 4, wherein the seating cover is made of a 70% rayon/viscose and 30% polyester blend.

6. The seating cover of claim 1, wherein the seating cover is made of a disposable fabric.

7. The seating cover of claim 1, wherein the advertising content is represented on both the inner and outer surfaces of the cover.

8. The seating cover of claim 1, wherein the advertising content is represented on both the front and rear surfaces of the cover.

9. The seating cover of claim 1, wherein the advertising content is represented on the rear portion of the seat for viewing from behind the seat.

10. The seating cover of claim 1, wherein the advertising content is represented on both the inner and outer surfaces of the cover.

11. The seating cover of claim 1, wherein the seating cover is biodegradable.

12. The seating cover of claim 1, wherein the seating cover is antimicrobial.

13. The seating cover of claim 1, wherein the seating cover comprises moisture managing fabric.

14. The seating cover of claim 1, wherein the seating cover comprises electrostatic fabric for affixing to a seating surface.

15. The seating cover of claim 1, wherein the seating cover comprises electrostatic fabric for affixing advertising content to a seating surface.

16. The seating cover of claim 1, wherein the seating cover comprises a scented fabric.

17. The seating cover of claim 1, wherein the seating cover is packaged in dispensers for installation.

18. The seating cover of claim 1, wherein the seating cover is utilized in cinema theaters.

19. The seating cover of claim 1, wherein the seating cover is utilized in performance venues.

20. The seating cover of claim 1, wherein the seating cover is utilized in school auditoriums.

21. The seating cover of claim 1, wherein the seating cover is utilized on passenger trains.

22. The seating cover of claim 1, wherein the seating cover is utilized on airplanes.

23. The seating cover of claim 1, wherein the seating cover is utilized in autobuses.

24. The seating cover of claim 1, wherein the seating cover is utilized in commercial vehicles.

25. The seating cover of claim 1, wherein the seating cover is utilized in rowed seating arrangements.

26. A method for providing advertising content comprising:
placing a protective seat cover mad of fabric over a seat;
said fabric having an inner layer and an outer layer;
wherein the fabric comprises one or more surfaces for presenting graphical or written advertising content.
